(19) United States
(12) Patent Application Publication
(10) Pub. No.: US 2009/0319469 A1
(43) Pub. Date: Dec. 24, 2009

(54) AUTOMATIC SELECTION AND RETRIEVAL OF METRICS FOR DISPLAY ON USER INTERFACES

(75) Inventors: Michael Lesser, Melbourne, FL (US); Mike Gilger, Satellite Beach, FL (US)

Correspondence Address: DR. MICHAEL LESSER;FYI CORPORATION, 405 ATLANTIC STREET, MELBOURNE, FL, 32951, US

(73) Assignee: FYI Corporation, Melbourne, FL (US)

(21) Appl. No.: 12/141,650

(22) Filed: Jun. 18, 2008

(51) Int. Cl. G06F 17/30

(52) U.S. Cl. 707/1; 707/E17.001

(57) ABSTRACT

A system and method for automatic selection and retrieval of metrics for display on user interfaces. A selection of a model of an entity or process stored on a computer readable medium is received. Definitions of metrics regarding the entity or process extracted are extracted from the model. Source information for data reflecting the values of the metrics is extracted from a database containing data source information. Data relating to each metric is retrieved for display on a user interface.

### RELATED APPLICATIONS

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The invention is directed to improvements in selection of data for display on user interfaces and more particularly to improvements in automatic selection of metrics related to one or more problem domains for display on user interfaces.

### BACKGROUND OF THE INVENTION

Conducting business today means collecting and coping with tremendous amounts of detailed data. A range of sophisticated business technologies-including enterprise resource planning, business intelligence, enterprise content management, business process management, business performance management, and supply chain management systems—have been developed to gather, organize, and/or analyze business data to help decision-makers reach better decisions by improving their understanding of the current state of their business. To disseminate this data to decision-makers, these technologies use various on-screen reporting tools such as tables, charts, graphs, and other data display constructs.

Unfortunately, such tools often create complex, interrelated, multi-dimensional reporting-displays that do little to facilitate the consumption and/or interpretation of that data by the decision-makers. This significantly reduces the benefits that these technologies aim to deliver in the first place. What is needed are advanced data-visualization technologies that takes advantage of both static and near real-time data, from diverse data sources, to drive intelligent reports and interfaces that intuitively facilitate quick understanding of evolving events in complex and dynamic situations.

The construction of such interfaces is, however, often a complex and labor intensive process. The first, and at times most complex, steps in such a process include identifying problem domains to be analyzed, identifying metrics related to the identified problem domains, determining the source of data that determine the values of the metrics, and the development of processes to access such data. Such steps could be significantly simplified and improved by process that automatically identifies problem domains, metrics, source data for metrics, and which generates processes to access source data.

### SUMMARY OF THE INVENTION

In one embodiment, the invention is directed to a method and computer-readable medium having computer-executable instructions for the method. A selection of a model of an entity or process stored on a computer readable medium is received from a user over a network. Definitions of metrics regarding the entity or process are extracted from the model using a first computer. Source information for data reflecting the values of the metrics is extracted from a database containing data source information using a second computer. Data relating to each metric are retrieved for display on a user interface using a third computer. The first computer, the second computer, and the third computer may be the same computer or any combination of two or three separate computers which are operatively connected to one another.

In another embodiment, the invention is directed to a system comprising: a model selection module that enables a user to select a model of an entity or process stored on a computer readable medium; a metric extraction module that extracts the definitions of metrics regarding the entity or process from the model; a data source information extraction module that extracts source information for data reflecting the values of the metrics from a database containing data source information; and a data retrieval module that retrieves data relating to each metric for display on the generated user interface.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

FIG. 1 is a flow chart of a process implementing one embodiment of a process which automates the selection and retrieval of metrics for display on user interfaces.

FIG. 2 illustrates one embodiment of a physical system 2000 capable of supporting at least one embodiment of the disclosed system and method.

FIG. 3 illustrates one embodiment of modules comprising a central server capable of supporting at least one embodiment of the disclosed system and method.

### DETAILED DESCRIPTION OF EMBODIMENTS OF THE INVENTION

The present invention is described below with reference to block diagrams and operational illustrations of methods and devices to store and/or access information regarding selection and retrieval of metrics for display on user interfaces. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

For the purposes of this disclosure a module is a software, hardware, or firmware (or combinations thereof system, process or functionality, or component thereof, that performs or facilitates the processes, features, and/or functions described herein (with or without human interaction or augmentation). A module can include sub-modules. A software or firmware module may be stored on a computer readable medium. A module may be implemented on one or more servers.

An Automated Process

The development of user interfaces may be significantly enhanced by a partially or fully automated process that uses preexisting business or process models to select problem sets, metrics, and sources for metrics. For the purposes of this disclosure, a model is a logical representation of one or more entities or processes stored on a computer readable medium. Such entities may include, without limitation, a business organization or subunits within a business organization. Such processes may include, without limitation, business processes or manufacturing processes. Models may be developed using open-standard-based, proprietary or in-house modeling tools. One example of an open-standard modeling language for such modeling tools is the BPMN (Business Process Modeling Notation) modeling language published by Object Management Group of Needham, Mass.

Business modeling tools enable businesses and organizations to model their processes and to see how different assumptions about future actions will affect performance. Modeling is an important part of understanding and restructuring the activities and information a typical business uses to achieve its business goals. These tools allow a business to model, document, and restructure the key activities a business undertakes. It also defines the kind of information the business needs to successfully engage in those activities, and some even include the definition of the metrics that determine the health of the activities as well as the expectation levels of those metrics.

The development of user interfaces may also be significantly enhanced by a partially or fully automated process that uses data exploration tools to automate the location and delivery of data to the interface from source data feeds. Such tools may provide a number of services including, without limitation, identifying data of interest, locating sources for data of interest, and retrieving data of interest.

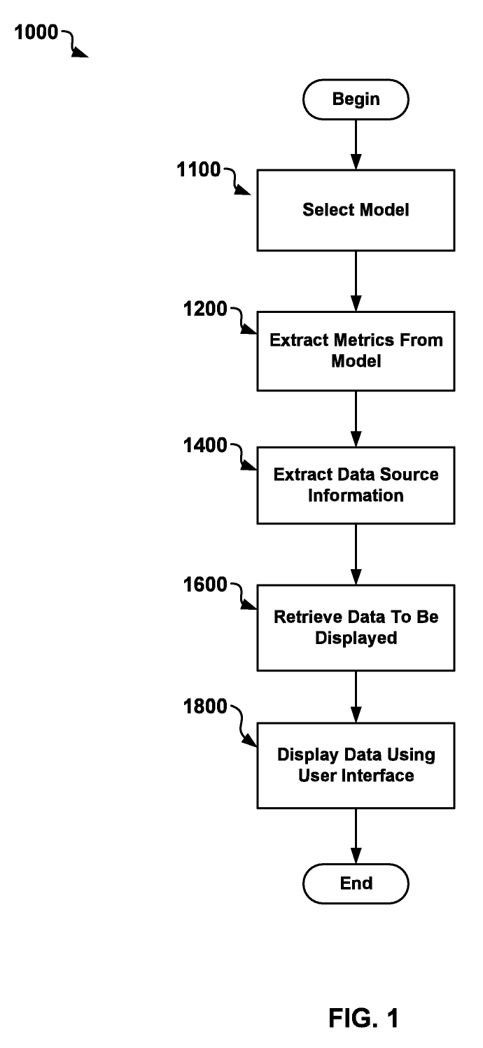

One embodiment of a process 1000 which automates the selection and retrieval of metrics for display on a user interface is shown FIG. 1. In step 1100, a model is selected. In step 1200, a metric extraction process extracts definitions of metrics related to one or more objects within the model. In step 1400, source information is extracted for data which reflects the values of the metrics displayed or otherwise used in a user interface. In step 1600 data reflecting the values of the metrics which are to be displayed or otherwise used in the user interface are retrieved from their respective data sources using data feeders which provide access to the data in push or pull mode. Finally, the retrieved data is displayed 1800 to the end user on a display device using a user interface.

Processes which may be employed to implement embodiments of steps described above will now be described in greater detail.

Selecting a Model

In one embodiment, a model of an organization or a process is selected as a first step in the selection and retrieval of metrics for display on a user interface reflecting all, or a portion, of the model. The model may relate to an entity or process. In one embodiment, the model is selected using the user interface of the modeling tool used to develop the model. In another embodiment, the model is selected by a separate user interface, for example, an ASP page.

Models may be developed using commercial modeling tools, such as, without limitation, Popkin Software's System Architect, PTech's Enterprise Framework, Computas' Metis Enterprise tool suite, IBM's WebSphere Business Modeler, Aris' Adonis, or MID's Innovator. Models may be developed entirely within an organization. Where an organization lacks sufficient maturity or resources to define adequate models, they may choose to reach out to best practice organizations, consultants, and/or industry groups within or related to their business space and leverage their accumulated industry domain knowledge possessed by such individuals or groups.

The knowledge possessed by such individuals or groups has been accumulated through years of practice in solving related problems and finding best practices that the business can perform to mitigate problems. Thus, in many cases, models contain sophisticated information not possessed or fully understood by anyone within an organization. Thus, best practice solutions modeled in business modeling tools allow a business to leverage the tool to develop the necessary process improvements within their organization. The potential benefits provided by such models and the knowledge contained within them can be exploited using user interfaces.

Extracting Metrics

In one embodiment, the selected model includes metrics relating to objects within the model. For the purposes of this disclosure a metric is a property of an object within a model, such as, for example, the monthly sales (the metric) for a sales person (the object). The value of a metric is determined by one or more data, alone, or combined by some manner of mathematical or analytic operation or mapping. The value may be temporal, that is, relating to a specific time period, may be constant, or may change periodically.

The process for extracting metrics may reside within the modeling tool, may access the modeling tool's database directly or obtain metrics from the model using various tools such as Application Programming Interfaces (APIs) that allow access to the models as they are defined and/or through various exporting tools that output XML based or other modeling languages such as Unified Modeling Language or UML2 Activity Diagrams, Event Driven Process Chains, Business Process Modeling Notation and others. Through the use of the API's and exports, the process can directly interrogate the model, and then determine the specific business problem that the user of the tool is trying to model and which metrics support that model.

In one embodiment, metrics are automatically selected for extraction by the metric extraction process. One advantage of such a feature is that an end user who is executing the process does not need to fully understand the model, have a clear idea of what problems the model may be used to address, or what activities the model may be used to monitor or control. Knowledge of entities and processes is embedded within the model and the extract process uses such information to select metrics of interest and relate them to one another. In one embodiment, metrics related to a specific problem domain are extracted, for example, sales within an organization or steps within a process.

In one embodiment, the most important metrics within the problem domain are selected, and less important elements are ignored. Such a selection may be based on an inherent property of the metric, for example, if the metric represents a unique identifier for an object, it may be considered important or essential. Such a selection may be based on an indication within the model that the metric is a key property of an object. Such a selection may be based on the domain of the metric, for example, fields representing dollar values may be considered important. The selection process may further limit the total number metrics selected to preserve interface clarity.

In one embodiment, where a model does not exist for a subject area of interest, or such a model is incomplete or inaccurate, the metric extraction process may provide a user interface which allows an end user to manually select specific metrics in the database of a data exploration tool for inclusion in a user interface.

Such tools may contain one or more databases which define data available within a one or more information processing systems. Such data definitions may include, without limitation, descriptions of data elements, the format of such data elements, the relationship such data elements to one another, the relationship of such data elements to metrics within models, the location of sources for such data elements, and methods which must be used to access data elements. Such tools, may include, without limitation, Applix's (Cognos) Executive Viewer, DataMind's DataCruncher, SAS Institute's Enterprise Miner, Cognos's Scenario, IBM's Intelligent Miner, Microsoft Query, TIBCO's DataExchange, Informatica's Data Explorer, and Trillium's Data Discovery.

Extracting Source Information for Data Relating to Metrics

For the purposes of this disclosure source information is defined as comprising the physical or logical location of data relating to a metric, for example, a server, a network address, an HTTP document displayed over the Internet or on an intranet, or an application program accessible through a network. Source information may further comprise information which specifies the format of the data, including any encoding. Source information may further comprise information specifying the physical format of the data, such as, for example, a database table or a spreadsheet. Source information may further comprise information necessary to access the data, such as, in the case of a database, a query or stored procedure to retrieve the data, or in the case of a spreadsheet, a row and column range, or in the case of an application program, an API definition.

In one embodiment, the source information extract process may extract data source information from a data source information database. In one embodiment, the database containing data source information is implemented and maintained using a data exploration tool. Alternatively, the database containing data source information may be maintained manually. In another embodiment, the data source information database is maintained by the modeling tool used to develop the model. In one embodiment, the source information is obtained directly from the data source information database. In another embodiment, the source information is obtained from the data source information using an API of a data exploration tool or the modeling tool. Other methods for retrieving data source information from a database will be readily apparent to those skilled in the art, and such methods are within the intended scope of this disclosure.

Alternatively, or additionally the source information extract process may allow data source information to be entered manually by an end user. Manual entry of source data information may be useful or necessary where a data source information database is not available, is inaccurate, and/or incomplete. Manual entry of data source information may also be useful where an end user wishes to use a specific data source where multiple sources for data for a metric exist. In one embodiment, manual entry of data source information is supported by a user interface integrated into components of the source information extract process.

Retrieving Data to Be Displayed on a User Interface

In one embodiment of a data retrieval process, for example, step 1600 of FIG. 1, data reflecting the values of the metrics which are to be displayed or otherwise used in a user interface are retrieved from their respective data sources using data feeders which provide access to the data in push or pull mode. In one embodiment, push mode data feeders may push data from data sources to the data retrieval process on a real time or scheduled basis. In one embodiment, the data feeders may be polled by the data retrieval process on a periodic or scheduled basis. In one embodiment, the data feeders are automatically configured using data source information data supplied by a data source extraction process. In one embodiment, the data feeders are configured manually by an end user using information supplied by a data source extraction process.

In one embodiment, data feeders may be components within a user interface. In another embodiment, data feeders may be a separate application, may be a component of the data exploration tool, or may be a component of a modeling tool. Other methods for structuring the data retrieval process will be readily apparent to those skilled in the art, and such are within the intended scope of this disclosure.

Data feeders may comprise applications which acquire data using strategy patterns whereby each strategy for data access is defined within an interchangeable construct that provides dynamic strategy selection on-the-fly as data needs are determined. In one embodiment, strategies are encapsulated into objects with well-defined interfaces that allow for dynamic instantiation based on needs, instead of the rigidly defined rules that may not be scalable or adjust to changes in the data streams.

In one embodiment, data sources which reside on external resources or families, such as databases or spreadsheets are have a defined external resource strategy. The external resource strategy may contain information about the type of external resource that it can access and implementation-specific details on how to access that resource. The external resource strategy may further define the format of result data objects which are to be returned by a component implementing an external resource strategy.

The type of resource may be a general classification such as a spreadsheet, database, or Web Service. The type may also include a sub-classification such as “Excel” or “Open Office” for spreadsheet, “Oracle” or “DB2” for database, “SAP HR Data Services,” or “Oracle Financials” for Web Service. In one embodiment, every elemental display unit or graphical symbol displayed on a user interface is mapped into a data request definition that specifies the external resource desired, as well as more specific information about the data itself, such as, for example, information to identify specific data elements within the external resource.

For example, if data relating to a given display unit resided in a specific row and column of an Excel spreadsheet, the data request definition for the element specifies an external resource strategy. The external resource strategy specifies how to find and open the file and locate the specific information. The external resource strategy may be packaged as a pre-defined method available for use by the data retrieval process, for example, by a data feeder.

In one embodiment, an external resource strategy may also specify levels of access. For instance, in the example above, the data defined within the data request definition for a data element in the user interface used row and column (address) information. On the other hand, if the data request definition defined an alias (instead of an address) for the data, the external resource strategy may specify that it supports the more abstract (higher-level) information-extraction-level of access, such as alias lookups within a target Excel spreadsheet.

In one embodiment, the data retrieval process may select one out of a plurality of external resource strategies. Continuing with the above example, if the data request definition defined row and column information, a lower-level external resource strategy for Excel spreadsheet access is selected. Such a lower-level external resource strategy—with lower-abstraction levels—is a “lighter” and faster resource. Whereas the higher-level Excel spreadsheet external resource strategies provide more utility and ease of data definition with its higher-abstraction services, but at a cost in performance.

In another example, if the data defined for use by a user interface resides on a DB2 database, the data retrieval process could interact with various DB2 external resource strategies, depending on how the data access was defined. For instance, a DB2 external resource strategy might understand a single database (very-low-level), with all elements about that database defined within the external resource strategy. In such a case a data retrieval process may simply pass the table, the column name, and a row identifier to a component implementing the external resource strategy which may then perform a simple lookup. The process is very fast, but a significant amount of descriptive data must be passed from the data retrieval process to the component implementing the external resource strategy. A higher-level external resource strategy, on the other hand, might understand one or more databases, and have built-in queries that would understand specifically how to access data. For such a higher-level external resource strategy, the data retrieval process would pass the component implementing the external resource strategy the database name and the query ID. Other levels could be defined depending on the level of abstraction desired between the external resource and the data retrieval process.

In another example, an external resource strategy for a single table of data from a JDBC database may include: a Driver Class, which is the class name of the JDBC driver needed for connecting to the database; a Database URL, which is the database-connection URL; a Database Principle, which is an authorized user name; a Database Credential, which is the authorized user's password; a Query, which is a request for specific data within the table; and an Attribute Map, which indicates how columns from the query-result-set are mapped to result-data-objects.

In another example, an external resource strategy for a single table of data from a web services domain may include: the URL (web address) of the service; a Principle, which is an authorized user name, a Credential, which is the authorized user's password; a Filtering Criterion such as a filtering string for retrieving data; and an Attribute Map which indicates how data from the service result-set is mapped into the necessary result-data-objects.

External resource strategies need be not be limited to data mapping which is pre-defined or fixed within the construction of the ERS. One limitation with a fixed data mapping approach is that each new external data source requires the construction of a new custom external resource strategy, creating another manual process for the user, and increases system maintenance, even though many strategies perform essentially the same activity—with the only difference being the data source. A more advanced form of an external resource strategy gains flexibility by using semantic information (metadata and/or ontologies) within inference modules. In one embodiment, these semantic-information-inference modules use mapping rules from expert systems and ontology methodologies to exchange or translate data among available data sources. In one embodiment, an inference module's extends its understanding of external-resource data automatically.

In one embodiment, an expert-system method of data mapping is built around an inference module which uses a process that derives a conclusion based solely on what is already known utilizing both forward and backward reasoning based on certain conditions—“if” the method infers certain consequences “then” do a specified activity. The inference module makes use of pattern recognition for conditional matching, and generates closest-match results rather than absolute results. The module is constructed of functions that are tuned according to examples (observations or patterns) fed into them. Each pattern belongs to a certain predefined data-classification class. A data-classification class is simply a specific mapping decision that has to be made. When a new pattern is received, that pattern is classified based on patterns previously received by the module.

A classifier within the inference module can be trained in various ways. In one embodiment, the invention employs a statistical machine-learning approach, though several learning approaches can be used, modified, and adapted to create successful classifiers. In one embodiment, fuzzy logic is utilized as the data-mapping classifier. Fuzzy logic deals with reasoning (the cognitive process of looking for reasons, beliefs, conclusions, actions, or feelings) that is approximately (rather than precisely) deduced from classical predicate logic (formal deductive system used by mathematicians, linguists, and computer scientists). In this case, it deals with well thought out, real-world, expert values for a complex problem. Instead of dealing with probabilities (the likelihood of some event or condition, i.e., how probable is it that a discrete piece of data is in a mapped set) which are conceptually distinct, fuzzy logic deals in degrees of “truth” and represents membership in vaguely defined sets (i.e., how frequently a discrete piece of data is mapped in one set versus another).

In one embodiment, an ontology based method of data mapping is built around an inference module that uses a process that derives conclusions through the use of ontologies (based on how to resolve semantic conflicts between heterogeneous data sources). For example, if two organizations merge their data sources, definitions in the data-source schemas associated with each can have different meanings—earnings, for instance, can mean profits in dollars for one data source and total sales in the other. In this case, the use of ontologies to explicitly define schema terms enables the inference module to identify unambiguous entities in each of the data sources to resolve these types of conflicts.

Specifically, ontologies enable accurate interpretation of data from multiple sources through the unambiguous classification of terms and relationships defined in the ontology, and they help verify the mappings used to integrate data from multiple sources. In one embodiment, the various ontologies must subscribe to a top-level vocabulary that defines the basic terms of the data ontology family. This ensures that the ontologies can all interact with a common vocabulary, and it ensures that a single external resource strategy can interact and automatically integrate with a new external source without manual intervention.

In one embodiment, expert system mapping and ontology mapping may extend the mapping process with data mining to find interesting trends or patterns in large data stores. Such patterns may guide the data mapping process into making better decisions about data mapping. Data mining has been used in many fields, but in relation to this invention, it is used to find frequent patterns in large data sets (See, e.g., R. Agrawal and R. Srikant. Fast Algorithms for Mining Association Rules. Very Large Data Bases (VLDB) Conference, pages 487-499, Morgan Kaufmann, 1994.) In this implementation, the mining of interesting patterns (rules) across heterogeneous data resources is the key to improving the mapping capabilities of the classifier. Generated data-mining rules (across different data resources) are used by a data classifier within an inference module to create more accurate data mappings. Data mining may also be fed by the inference module through a closed-loop system to provide feedback to the data-mining process for finding additional trends and patterns.

Displaying the Retrieved Data

In one embodiment, data retrieved by a data retrieval process, for example, step 1600 of FIG. 1, is displayed by a user interface. The user interface may be any manner of user interface known to persons skilled in the art which may be adapted to the display of data. For example, without limitation, such interfaces may include: a graphical user interface that presents data relating to metrics as numbers or any form of symbolic representation; a graphical user interface having charts or graphs; spreadsheets; formatted text reports; HTTP documents; or structured data files such as XML.

In one embodiment, graphical elements in a user interface may be composed of a plurality of elemental display units wherein each of the elemental display units has one or more easily recognized properties such as, for example, color, intensity, or pattern, that relates to the value of one or more metrics. One type of elemental display units are knowledge enhanced elemental display units. For the purposes of this disclosure, a knowledge enhanced elemental display unit is a display object whose properties reflect the state of a property or a group of related properties of a specific subject. For example, the element may reflect sales for a salesperson for the current month.

Such elemental display units are said to be knowledge enhanced since the display of the element reflects not only the value of a metric, but also may reflect an interpretation of the value of the metric. For example, in the case of the salesperson referenced above, the color or pattern may reflect whether the salesperson's are above or below projected or budgeted sales, and may further reflect degrees of underperformance. The value to an end user of such knowledge enhanced elements is that the state of the subject matter to which the element relates is recognized at a glance.

Knowledge enhanced graphical display units may be visually grouped into sets, Such sets may display multiple properties for a specific subject and allow the state of all such properties to be recognized rapidly. Grouping such elements into a suggestive shape may further enhance the information conveyed in the symbol. One example of such knowledge enhanced graphical symbols is described in U.S. Pat. No. 5,321,800, entitled “Graphical Language Methodology for Information Display”. U.S. Pat. No. 5,321,800 describes icons which display the state of a hospital patient's condition. The icon is composed of sets of knowledge enhanced elemental display units shaped in a manner suggestive of a human being, each elemental display units reflecting metrics related to a portion of the patient's body.

Knowledge enhanced graphical display units may be disposed across a background displayed on a display unit in such a manner that suggests the physical or conceptual location of the subject matter to which the graphical units relates, and may further suggest the relationship of the graphical symbols to one another. One example of such knowledge enhanced graphical symbols is described in U.S. patent application Ser. No. 11/406,774, entitled “Displaying Common Operational Pictures. U.S. patent application Ser. No. 11/406,774 describes user interfaces in which knowledge enhanced graphical units are disposed in a user interface in a manner that suggests, for example, the geographical location of military units or business entities and the relative position of such units with respect to one another.

In one embodiment, the user interface provides a data feed registration API and a data feed interface API to interface to data feeders, such as those described above. The data feed registration API may allow specific data feeds to be associated with specific graphical display units displayed on the user interface. The data feed interface API may allow the interface to receive data from registered data feeds, as well as control the behavior of the data feeds.

### Physical Implementation

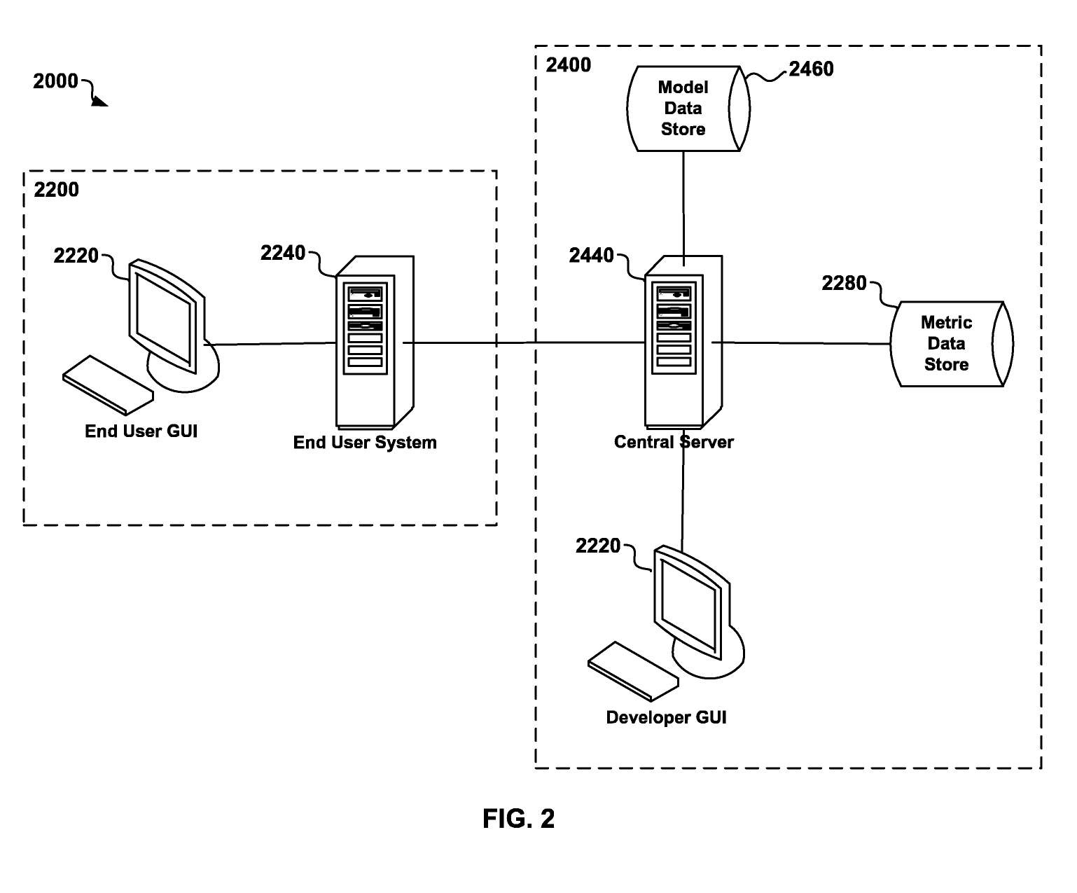

FIG. 2 illustrates one embodiment of a physical system 2000 capable of supporting at least one embodiment of the disclosed system and method. In one embodiment, steps 1100-1600 of FIG. 1 are implemented by modules hosted on a central server 2440 at a central server location 2400. Where such steps require manual steps, a developer may input required data using a developer GUI accessible through a display unit 2420. Model data and data relating to metrics are stored on storage devices 2260 and 2280, respectively connected to the central server. An end user at an end user location may display data using a user interface, for example, step 1800 of FIG. 1, on an end user GUI on an end user display device 2260. Requests for data and processes capable of supporting the end user interface may be hosted on an end user system.

In one embodiment, all of the steps 1100-1600 are implemented by modules which are integrated into a modeling tool or the data exploration tool. In another embodiment, each of the steps are implemented using stand alone modules or groups of modules, where data is passed between modules in each step using API's or interface files. The modules implementing each step may be located and executed on a single system, or may each reside on separate systems which are connected with each other by a common network such as a LAN, WAN, or the Internet. Other methods for structuring modules and implementing steps 1100-1800, as well as their location on a common network will be readily apparent to those skilled in the art, and such structures are within the intended scope of this disclosure.

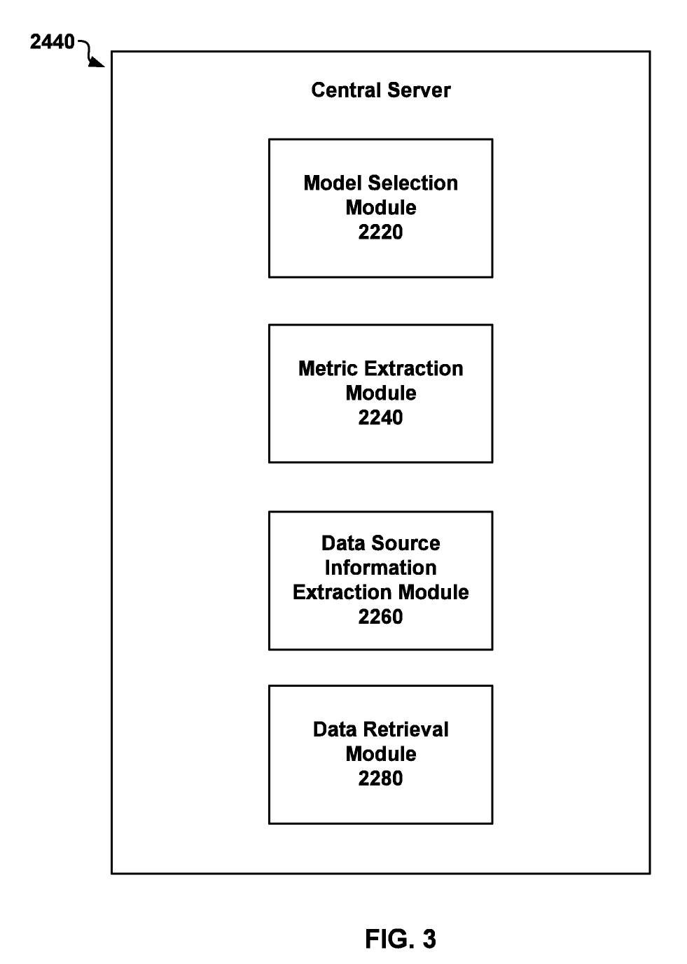

FIG. 3 illustrates one embodiment of a central server 2440 capable of supporting at least one embodiment of the disclosed system and method. A model selection module 2220 enables an end user or developer to enter a selection of a model of an entity or process stored on a computer readable medium using a user interface. Alternatively, a metric selection module (not shown) may be used to select metric definitions stored on a computer readable medium, for example, in the database of a data mining tool. A metric extraction module 2240 extracts metrics definitions regarding the selected entity or process from the model or from a data mining tool.

A data source information extraction module 2260 extracts source information for data reflecting the values of the metrics from a database containing data source information, for example, a database associated with the selected model or a data mining tool. A data retrieval module 2280 retrieves data which is to be displayed by a user interface from one or more data sources. In one embodiment, the data retrieval module further comprises data feeder modules that utilize external resource strategies to access source data. In one embodiment data feeder modules further comprise one or more inference modules which include data classifiers, and are capable of dynamically adjusting data access using, for example, expert system or ontology based methodologies.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim:

1. A method comprising the steps:
receiving, over a network, a selection of a model of an entity or process stored on a computer readable medium;
using a first computer, extracting definitions of metrics regarding the entity or process from the model;
using a second computer, extracting source information for data reflecting the values of the metrics from a database containing data source information;
using a third computer retrieving data relating to each metric for display on a user interface,
wherein the first computer, the second computer, and the third computer may be the same computer or any combination of two or three separate computers which are operatively connected to one another.

2. The method of claim 1 wherein the user interface is a graphical user interface comprising at least one knowledge enhanced elemental display units.

3. The method of claim 2 wherein at least one knowledge enhanced elemental display units are disposed across a background on the user interface in a manner which suggests one or more properties of the data to which each graphical symbol relates.

4. The method of claim 2 wherein the at least one knowledge enhanced elemental display units are disposed across a background in a manner which suggests one or more relationship between the symbols.

5. The method of claim 1 wherein the data relating to each metric is stored in an external resource, and an external resource strategy which maps the data within the external resource is used to retrieve the data.

6. The method of claim 5 wherein the external resource strategy specifies that data mapping is dynamic.

7. The method of claim 6 wherein the external resource strategy wherein dynamic data mapping is performed using an expert system or ontology based methodology.

8. A computer-readable medium having computer-executable instructions for a method comprising the steps of:
receiving, over a network, a selection of a model of an entity or process stored on a second computer readable medium;
using a first computer, extracting definitions of metrics regarding the entity or process from the model;
using a second computer, extracting source information for data reflecting the values of the metrics from a database containing data source information;
using a third computer retrieving data relating to each metric for display on a user interface,
wherein the first computer, the second computer, and the third computer may be the same computer or any combination of two or three separate computers which are operatively connected to one another.

9. The computer-readable medium of claim 8 wherein the user interface is a graphical user interface comprising at least one knowledge enhanced elemental display units.

10. The computer-readable medium of claim 9 wherein at least one knowledge enhanced elemental display units are disposed across a background on the user interface in a manner which suggests one or more properties of the data to which each graphical symbol relates.

11. The computer-readable medium of claim 9 wherein the at least one knowledge enhanced elemental display units are disposed across a background in a manner which suggests one or more relationship between the symbols.

12. The computer-readable medium of claim 8 wherein the data relating to each metric is stored in an external resource, and an external resource strategy which maps the data within the external resource is used to retrieve the data.

13. The computer-readable medium of claim 12 wherein the external resource strategy specifies that data mapping is dynamic.

14. The method of claim 13 wherein the external resource strategy wherein dynamic data mapping is performed using an expert system or ontology based methodology.

15. A system, comprising:
a model selection module that enables a user to select a model of an entity or process stored on a computer readable medium;
a metric extraction module that extracts the definitions of metrics regarding the entity or process from the model;
a data source information extraction module that extracts source information for data reflecting the values of the metrics from a database containing data source information;
a data retrieval module that retrieves data relating to each metric for display on the generated user interface.

16. The system of claim 15 wherein the user interface is a graphical user interface comprising at least one knowledge enhanced elemental display units.

17. The system of claim 16 wherein the at least one knowledge enhanced elemental display units are disposed across a background on the user interface in a manner which suggests one or more properties of the data to which each graphical symbol relates.

18. The system of claim 16 wherein the at least one knowledge enhanced elemental display units are disposed across a background in a manner which suggests one or more relationship between the symbols.

19. The method of claim 15 wherein the data relating to each metric is stored in an external resource, and data retrieval module uses an external resource strategy which maps the data within the external resource to retrieve the data.

20. The method of claim 19 wherein the external resource strategy specifies that data mapping is dynamic.

21. The method of claim 20 wherein the dynamic data mapping is performed by an interference module within the data retrieval module using an expert system or ontology based methodology.
